(19) United States
(12) Patent Application Publication
(10) Pub. No.: US 2024/0168770 A1
(43) Pub. Date: May 23, 2024

(54) Method, System, and Computer Program Product for Grading an API Specification

(71) Applicant: Visa International Service Association, San Francisco, CA (US)

(72) Inventors: Thiyagarajan Velappan, Katy, TX (US); Devang Vrajlal Dholakia, Cedar Park, TX (US)

(21) Appl. No.: 17/990,796

(22) Filed: Nov. 21, 2022

(51) Int. Cl. G06F 9/445; G06F 9/38; G06F 9/54

(52) U.S. Cl. CPC G06F 9/44505; G06F 9/3836; G06F 9/541

(57) ABSTRACT

A method, system, and computer program product is provided for grading an application programming interface (API) specification. The method includes receiving an API specification and automatically grading the API specification using rules by: parsing the API specification into segments; and for each rule, extracting, at least one segment corresponding to the rule from the API specification and applying the rule to the at least one segment to determine compliance data for the at least one segment with the rule. A violation of at least one rule may be automatically identified based on the compliance data. A report for the API specification may be generated based on the at least one violation, where the report includes data associated with the violation and at least one score. The report may be displayed on a user interface including at least one interactive feature configured to facilitate remediation of the at least one violation.

### BACKGROUND

### 1. Field

This disclosure relates generally to application programming interface (API) specifications and, in non-limiting embodiments or aspects, to methods, systems, and computer program products for grading API specifications.

### 2. Technical Considerations

Application programming interface (API) specifications are a collection of rules which define the way two or more software applications communicate with one another. API specifications may be generated based on existing standards and audited using tools such as, OpenAPI 3.0, Swagger 2.0, and/or the like. Complying with such standards enables users to understand and interact with API specifications without accessing the source code.

It is difficult to grade API specifications and determine the severity of an instance of non-compliance with the standards. Additionally, existing techniques do not perform static analysis of API specifications and do not provide any metric that may be used to determine whether an API specification is compliant and safe for publication. In some cases, non-complaint API specifications are published and used as building blocks for products, causing security issues for those products.

### SUMMARY

According to non-limiting embodiments or aspects, provided is a method for grading an application programming interface (API) specification. In some non-limiting embodiments or aspects, the method may include receiving, with at least one processor, an API specification. In some non-limiting embodiments or aspects, the method may further include automatically grading, with at least one processor, the API specification using a plurality of rules by: parsing, with at least one processor, the API specification into a plurality of segments; and for each rule of the plurality of rules, extracting, with at least one processor, at least one segment of the plurality of segments corresponding to the rule from the API specification and applying, with at least one processor, the rule to the at least one segment to determine compliance data for the at least one segment with the rule. In some non-limiting embodiments or aspects, the method may further include, based on the compliance data, automatically identifying, with at least one processor, at least one violation of at least one rule of the plurality of rules occurring in the API specification. In some non-limiting embodiments or aspects, the method may further include generating, with at least one processor, a report for the API specification based on the at least one violation of the at least one rule, where the report comprises data associated with the at least one violation of the at least one rule and at least one score. In some non-limiting embodiments or aspects, the method may further include displaying, with at least one processor, the report on a user interface comprising at least one interactive feature configured to facilitate remediation of the at least one violation.

In some non-limiting embodiments or aspects, where the at least one interactive feature is a selectable button, the method may further include receiving a selection of the selectable button from a user; automatically modifying the API specification to correct the at least one violation of the at least one rule; and generating a second report for the API specification based on the modified API specification, where the second report comprises at least one second score. In some non-limiting embodiments or aspects, where the at least one interactive feature is a selectable link corresponding to the at least one segment of the plurality of segments, the method may further include receiving a selection of the selectable link from a user; displaying the at least one segment of the plurality of segments comprising the at least one violation of the at least one rule; and providing at least one recommendation to modify the at least one segment to correct the at least one violation of the at least one rule. In some non-limiting embodiments or aspects the method may further include generating the at least one score based on a number of unique violations and a number of the plurality of rules, where each rule of the plurality of rules has a corresponding weight. In some non-limiting embodiments or aspects the method may further include determining whether to allow or deny publication of the API specification based on the at least one score and a threshold value. In some non-limiting embodiments or aspects, the method may further include comparing the at least one score to the threshold value; determining that the at least one score does not satisfy the threshold value; and denying publication of the API specification based on determining that the at least one score does not satisfy the threshold value. In some non-limiting embodiments or aspects, the method may further include comparing the at least one score to the threshold value; determining the at least one score satisfies the threshold value; and automatically publishing the API specification based on determining the at least one score satisfies the threshold value. In some non-limiting embodiments or aspects, the user interface displays the API specification in a first portion of a window of the user interface and the report in a second portion of the window of the user interface, and the report interacts dynamically with the API specification.

According to non-limiting embodiments or aspects, provided is a system for grading an application programming interface (API) specification comprising at least one processor, where the at least one processor is programmed or configured to receive an API specification. In some non-limiting embodiments or aspects, the at least one processor is programmed or configured to automatically grade the API specification using a plurality of rules, where when grading the API specification, the at least one processor is programmed or configured to: parse the API specification into a plurality of segments; and for each rule of the plurality of rules, extract at least one segment of the plurality of segments corresponding to the rule from the API specification and apply the rule to the at least one segment to determine compliance data for the at least one segment with the rule. In some non-limiting embodiments or aspects, the at least one processor is programmed or configured to, based on the compliance data, automatically identify at least one violation of at least one rule of the plurality of rules occurring in the API specification. In some non-limiting embodiments or aspects, the at least one processor is programmed or configured to generate a report for the API specification based on the at least one violation of the at least one rule, where the report comprises data associated with the at least one violation of the at least one rule and at least one score. In some non-limiting embodiments or aspects, the at least one processor is programmed or configured to display the report on a user interface comprising at least one interactive feature configured to facilitate remediation of the at least one violation.

In some non-limiting embodiments or aspects, where the at least one interactive feature is a selectable button, the at least one processor is programmed or configured to: receive a selection of the selectable button from a user; automatically modify the API specification to correct the at least one violation of the at least one rule; and generate a second report for the API specification based on the modified API specification, where the second report comprises at least one second score. In some non-limiting embodiments or aspects, where the at least one interactive feature is a selectable link corresponding to the at least one segment of the plurality of segments, the at least one processor is programmed or configured to: receive a selection of the selectable link from a user; display the at least one segment of the plurality of segments comprising the at least one violation of the at least one rule; and provide at least one recommendation to modify the at least one segment to correct the at least one violation of the at least one rule. In some non-limiting embodiments or aspects, the at least one processor is further programmed or configured to generate the at least one score based on a number of unique violations and a number of the plurality of rules, where each rule of the plurality of rules has a corresponding weight. In some non-limiting embodiments or aspects, the at least one processor is further programmed or configured to determine whether to allow or deny publication of the API specification based on the at least one score and a threshold value. In some non-limiting embodiments or aspects, the at least one processor is further programmed or configured to: compare the at least one score to the threshold value; determine whether the at least one score satisfies the threshold value; and deny publication of the API specification based on determining that the at least one score does not satisfy the threshold value; or automatically publish the API specification based on determining that the at least one score satisfies the threshold value. In some non-limiting embodiments or aspects, the user interface displays the API specification in a first portion of a window of the user interface and the report in a second portion of the window of the user interface, and the report interacts dynamically with the API specification.

In some non-limiting embodiments or aspects provided is a computer program product for grading an application programming interface (API) specification, the computer program product comprising at least one non-transitory computer-readable medium including one or more instructions that, when executed by at least one processor, may cause the at least one processor to: receive an API specification. In some non-limiting embodiments or aspects, the one or more instructions may further cause the at least one processor to automatically grade the API specification using a plurality of rules, where when grading the API specification, the one or more instructions may cause the at least one processor to: parse the API specification into a plurality of segments; and for each rule of the plurality of rules, extract at least one segment of the plurality of segments corresponding to the rule from the API specification and apply the rule to the at least one segment to determine compliance data for the at least one segment with the rule. In some non-limiting embodiments or aspects, the one or more instructions may further cause the at least one processor to, based on the compliance data, automatically identify at least one violation of at least one rule of the plurality of rules occurring in the API specification. In some non-limiting embodiments or aspects, the one or more instructions may further cause the at least one processor to generate a report for the API specification based on the at least one violation of the at least one rule, where the report comprises data associated with the at least one violation of the at least one rule and at least one score. In some non-limiting embodiments or aspects, the one or more instructions may further cause the at least one processor to display the report on a user interface comprising at least one interactive feature configured to facilitate remediation of the at least one violation.

In some non-limiting embodiments or aspects, where the at least one interactive feature is a selectable button, the one or more instructions may cause the at least one processor to: receive a selection of the selectable button from a user; automatically modify the API specification to correct the at least one violation of the at least one rule; and generate a second report for the API specification based on the modified API specification, where the second report comprises at least one second score. In some non-limiting embodiments or aspects, where the at least one interactive feature is a selectable link corresponding to the at least one segment of the plurality of segments, the one or more instructions may cause the at least one processor to: receive a selection of the selectable link from a user; display the at least one segment of the plurality of segments comprising the at least one violation of the at least one rule; and provide at least one recommendation to modify the at least one segment to correct the at least one violation of the at least one rule. In some non-limiting embodiments or aspects, the one or more instructions may further cause the at least one processor to generate the at least one score based on a number of unique violations and a number of the plurality of rules, where each rule of the plurality rules has a corresponding weight. In some non-limiting embodiments or aspects, the one or more instructions may further cause the at least one processor to: determine whether to allow or deny publication of the API specification based on the at least one score and a threshold value, where when determining whether to allow or deny publication of the API specification, the one or more instructions may cause the at least one processor to: compare the at least one score to the threshold value; determine whether the at least one score satisfies the threshold value; and deny publication of the API specification based on determining that the at least one score does not satisfy the threshold value; or automatically publish the API specification based on determining that the at least one score satisfies the threshold value.

Other non-limiting embodiments or aspects will be set forth in the following numbered clauses:

Clause 1: A computer-implemented method for grading an application programming interface (API) specification comprising: receiving, with at least one processor, an API specification; automatically grading, with at least one processor, the API specification using a plurality of rules by: parsing, with at least one processor, the API specification into a plurality of segments; and for each rule of the plurality of rules, extracting, with at least one processor, at least one segment of the plurality of segments corresponding to the rule from the API specification and applying, with at least one processor, the rule to the at least one segment to determine compliance data for the at least one segment with the rule; based on the compliance data, automatically identifying, with at least one processor, at least one violation of at least one rule of the plurality of rules occurring in the API specification; generating, with at least one processor, a report for the API specification based on the at least one violation of the at least one rule, wherein the report comprises data associated with the at least one violation of the at least one rule and at least one score; and displaying, with at least one processor, the report on a user interface comprising at least one interactive feature configured to facilitate remediation of the at least one violation.

Clause 2: The computer-implemented method of clause 1, wherein the at least one interactive feature is a selectable button, the method further comprising: receiving a selection of the selectable button from a user; automatically modifying the API specification to correct the at least one violation of the at least one rule; and generating a second report for the API specification based on the modified API specification, wherein the second report comprises at least one second score.

Clause 3: The computer-implemented method of clause 1 or clause 2, wherein the at least one interactive feature is a selectable link corresponding to the at least one segment of the plurality of segments, the method further comprising: receiving a selection of the selectable link from a user; displaying the at least one segment of the plurality of segments comprising the at least one violation of the at least one rule; and providing at least one recommendation to modify the at least one segment to correct the at least one violation of the at least one rule.

Clause 4: The computer-implemented method of any of clauses 1-3, further comprising generating the at least one score based on a number of unique violations and a number of the plurality of rules, wherein each rule of the plurality of rules has a corresponding weight.

Clause 5: The computer-implemented method of any of clauses 1-4, further comprising determining whether to allow or deny publication of the API specification based on the at least one score and a threshold value.

Clause 6: The computer-implemented method of any of clauses 1-5, further comprising: comparing the at least one score to the threshold value; determining that the at least one score does not satisfy the threshold value; and denying publication of the API specification based on determining that the at least one score does not satisfy the threshold value.

Clause 7: The computer-implemented method of any of clauses 1-6, further comprising: comparing the at least one score to the threshold value; determining the at least one score satisfies the threshold value; and automatically publishing the API specification based on determining the at least one score satisfies the threshold value.

Clause 8: The computer-implemented method of any of clauses 1-7, wherein the user interface displays the API specification in a first portion of a window of the user interface and the report in a second portion of the window of the user interface, and wherein the report interacts dynamically with the API specification.

Clause 9: A system for grading an application programming interface (API) specification comprising at least one processor, wherein the at least one processor is programmed or configured to: receive an API specification; automatically grade the API specification using a plurality of rules, wherein when grading the API specification, the at least one processor is programmed or configured to: parse the API specification into a plurality of segments; and for each rule of the plurality of rules, extract at least one segment of the plurality of segments corresponding to the rule from the API specification and apply the rule to the at least one segment to determine compliance data for the at least one segment with the rule; based on the compliance data, automatically identify at least one violation of at least one rule of the plurality of rules occurring in the API specification; generate a report for the API specification based on the at least one violation of the at least one rule, wherein the report comprises data associated with the at least one violation of the at least one rule and at least one score; and display the report on a user interface comprising at least one interactive feature configured to facilitate remediation of the at least one violation.

Clause 10: The system of clause 9, wherein the at least one interactive feature is a selectable button, and wherein the at least one processor is programmed or configured to: receive a selection of the selectable button from a user; automatically modify the API specification to correct the at least one violation of the at least one rule; and generate a second report for the API specification based on the modified API specification, wherein the second report comprises at least one second score.

Clause 11: The system of clause 9 or clause 10, wherein the at least one interactive feature is a selectable link corresponding to the at least one segment of the plurality of segments, and wherein the at least one processor is programmed or configured to: receive a selection of the selectable link from a user; display the at least one segment of the plurality of segments comprising the at least one violation of the at least one rule; and provide at least one recommendation to modify the at least one segment to correct the at least one violation of the at least one rule.

Clause 12: The system of any of clauses 9-11, wherein the at least one processor is further programmed or configured to generate the at least one score based on a number of unique violations and a number of the plurality of rules, wherein each rule of the plurality of rules has a corresponding weight.

Clause 13: The system of any of clauses 9-12, wherein the at least one processor is further programmed or configured to determine whether to allow or deny publication of the API specification based on the at least one score and a threshold value.

Clause 14: The system of any of clauses 9-13, wherein the at least one processor is further programmed or configured to: compare the at least one score to the threshold value; determine whether the at least one score satisfies the threshold value; and deny publication of the API specification based on determining that the at least one score does not satisfy the threshold value; or automatically publish the API specification based on determining that the at least one score satisfies the threshold value.

Clause 15: The system of any of clauses 9-14, wherein the user interface displays the API specification in a first portion of a window of the user interface and the report in a second portion of the window of the user interface, and wherein the report interacts dynamically with the API specification.

Clause 16: A computer program product for grading an application programming interface (API) specification, the computer program product comprising at least one non-transitory computer-readable medium including one or more instructions that, when executed by at least one processor, cause the at least one processor to: receive an API specification; automatically grade the API specification using a plurality of rules, wherein when grading the API specification, the one or more instructions cause the at least one processor to: parse the API specification into a plurality of segments; and for each rule of the plurality of rules, extract at least one segment of the plurality of segments corresponding to the rule from the API specification and apply the rule to the at least one segment to determine compliance data for the at least one segment with the rule; based on the compliance data, automatically identify at least one violation of at least one rule of the plurality of rules occurring in the API specification; generate a report for the API specification based on the at least one violation of the at least one rule, wherein the report comprises data associated with the at least one violation of the at least one rule and at least one score; and display the report on a user interface comprising at least one interactive feature configured to facilitate remediation of the at least one violation.

Clause 17: The computer program product of clause 16, wherein the at least one interactive feature is a selectable button, and wherein the one or more instructions cause the at least one processor to: receive a selection of the selectable button from a user; automatically modify the API specification to correct the at least one violation of the at least one rule; and generate a second report for the API specification based on the modified API specification, wherein the second report comprises at least one second score.

Clause 18: The computer program product of clause 16 or clause 17, wherein the at least one interactive feature is a selectable link corresponding to the at least one segment of the plurality of segments, and wherein the one or more instructions cause the at least one processor to: receive a selection of the selectable link from a user; display the at least one segment of the plurality of segments comprising the at least one violation of the at least one rule; and provide at least one recommendation to modify the at least one segment to correct the at least one violation of the at least one rule.

Clause 19: The computer program product of any of clauses 16-18, wherein the one or more instructions further cause the at least one processor to generate the at least one score based on a number of unique violations and a number of the plurality of rules, wherein each rule of the plurality rules has a corresponding weight.

Clause 20: The computer program product of any of clauses 16-19, wherein the one or more instructions further cause the at least one processor to: determine whether to allow or deny publication of the API specification based on the at least one score and a threshold value, wherein when determining whether to allow or deny publication of the API specification, the one or more instructions cause the at least one processor to: compare the at least one score to the threshold value; determine whether the at least one score satisfies the threshold value; and deny publication of the API specification based on determining the at least one score does not satisfy the threshold value; or automatically publish the API specification based on determining that the at least one score satisfies the threshold value.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for grading an application programming interface (API) specification according to non-limiting embodiments or aspects;

FIG. 2 is a diagram of non-limiting embodiments or aspects of components of one or more devices of FIG. 1;

FIG. 3 is a flowchart of non-limiting embodiments or aspects of a process for grading an API specification according to non-limiting embodiments or aspects;

FIGS. 4A-4C are diagrams of non-limiting embodiments or aspects of an implementation of a process for grading an API specification; and

FIG. 5 is an exemplary implementation of a user interface generated based on grading an API specification according to non-limiting embodiments or aspects.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices that are configured to directly or indirectly communicate with or over one or more networks. The computing device may be a mobile device. In other non-limiting embodiments or aspects, the computing device may be a desktop computer, a server, a group of servers, or other non-mobile computer. Furthermore, the term “computer” may refer to any computing device that includes the necessary components to receive, process, and output data, and normally includes a display, a processor, a memory, an input device, and a network interface. The term “application” or “application program interface” (API) may refer to computer code or other data sorted on a computer-readable medium that may be executed by a processor to facilitate the interaction between software components, such as a client-side front-end and/or server-side back-end for receiving data from the client. The term “interface” may refer to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “POS system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices such as, but not limited to, processors, servers, client devices, software applications, and/or other like components.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Provided herein are systems, methods, and computer program products for grading API specifications. Non-limiting embodiments or aspects of the present disclosure may include a system that includes at least one processor programmed or configured to receive an API specification and automatically grade the API specification using a plurality of rules. In some non-limiting embodiments or aspects, the at least one processor may be further programmed or configured to parse the API specification into a plurality of segments, and for each rule of the plurality of rules, extract at least one segment of the plurality of segments corresponding to the rule from the API specification and/or apply the rule to the at least one segment to determine compliance data for the at least one segment with the rule. In some non-limiting embodiments or aspects, the at least one processor may be further programmed or configured to automatically identify, based on the compliance data, at least one violation of at least one rule of the plurality of rules occurring in the API specification. In some non-limiting embodiments or aspects, the at least one processor may be further programmed or configured to generate a report of the API specification based on the at least one violation of the at least one rule, where the report may include data associated with the at least one violation of the at least one rule and/or at least one score. In some non-limiting embodiments or aspects, the at least one processor may be further programmed or configured to display the report on a user interface including at least one interactive feature configured to facilitate remediation of the at least one violation.

In some non-limiting embodiments or aspects, the at least one interactive feature may include a selectable button and/or a selectable link. In some non-limiting embodiments or aspects, the at least one processor may be further programmed or configured to receive a selection of the selectable button from a user; automatically modify the API specification to correct the at least one violation of the at least one rule; and/or generate a second report for the API specification based on the modified API specification, where the second report may include at least one second score. In some non-limiting embodiments or aspects, the at least one processor may be further configured to receive a selection of the selectable link from a user; display the at least one segment of the plurality of segments including the at least one violation of the at least one rule; and provide at least one recommendation to modify the at least one segment to correct the at least one violation of the at least one rule. In some non-limiting embodiments or aspects, the at least one processor may be further programmed or configured to generate the at least one score based on a number of unique violations and/or a number of the plurality of rules. In some non-limiting embodiments or aspects, each rule of the plurality of rules may have a corresponding weight. In some non-limiting embodiments to aspects, the at least one processor may be further programmed or configured to determine whether to allow and/or deny publication of the API specification based on the at least one score and a threshold value. In some non-limiting embodiments or aspects, the at least one processor may be further programmed or configured to compare the at least one score to the threshold value; determine that the at least one score does not satisfy the threshold value; and/or deny publication of the API specification based on determining the at least one score does not satisfy the threshold value. In some non-limiting embodiments or aspects, the at least one processor may be further programmed or configured to compare the at least one score to the threshold value; determine that the at least one score satisfies the threshold value; and/or automatically publish the API specification based on determining that the at least one score satisfies the threshold value. In some non-limiting embodiments or aspects, the user interface may display the API specification in a first portion of a window of the user interface and/or display the report in a second portion of the window of the user interface, where the report may interact dynamically with the API specification.

In this way, API specifications can be graded (e.g., tested and/or evaluated against API standards), and rule violations within the API specifications can be automatically identified in the reports and/or automatically remediated. The reports may include information about potential risks associated with rule violations, remediation plans, and/or suggested fixes for modifying the API specifications to be compliant with the rules being graded. Additionally, the reports may identify and organize the detected rule violations based on their respective severity levels, thereby allowing users to efficiently prioritize an order in which to address the violations. The reports may also include interactive features (e.g., selectable buttons and/or links), providing dynamic interactions between the API specifications and the reports. Such interactive features in the reports may be associated with non-compliant sections of the API specifications and/or provide remediation plans, automated modifications, and/or the like. Users may interact with the reports and/or the API specifications via user interfaces, which enables users to efficiently identify rule violations and/or fix rule violations through automated modification of non-compliant API specifications.

Additionally, the proposed solution provides at least one score (e.g., a grading score and/or a compliance score) which may reflect the risk of exposing the APIs (e.g., internally or externally). The scores may be generated based on the reports, the plurality of rules, and/or a number of rule violations. The scores may be used as a metric to automatically and/or efficiently determine whether or not to allow and/or deny publication of the API specifications, thereby reducing security issues caused by rule violations. In some cases, the scores may be used to track consistency across design and code repositories.

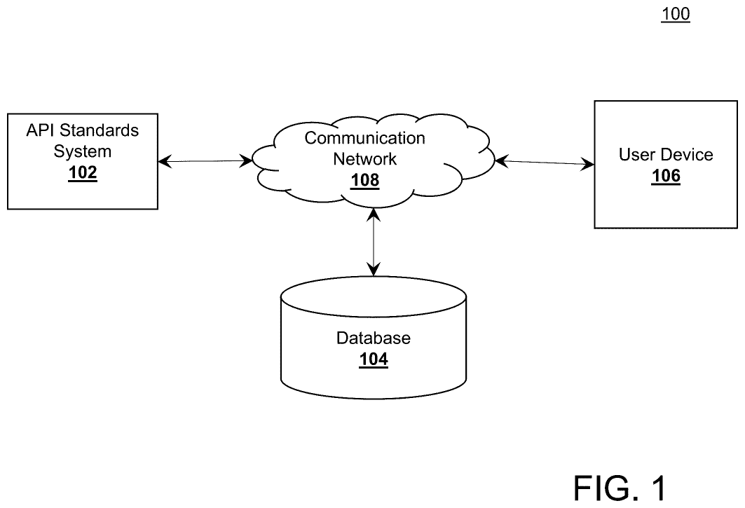

FIG. 1 is a schematic diagram of a system 100 for grading an API specification according to some non-limiting embodiments or aspects. System 100 may include API standards system 102, database 104, user device 106, and/or communication network 108. API standards system 102, database 104, and/or user device 106 may interconnect (e.g., establish a connection to communicate) via wired connections, wireless connections, or a combination of wired and wireless connections.

API standards system 102 may include one or more devices configured to communicate with database 104 and/or user device 106 via communication network 108. For example, API standards system 102 may include a server, a group of servers, and/or other like devices. In some non-limiting embodiments or aspects, API standards system 102 may be associated with a transaction service provider system, as described herein.

In some non-limiting embodiments or aspects, API standards system 102 may be in communication with a data storage device, which may be local or remote to API standards system 102. In some non-limiting embodiments or aspects, API standards system 102 may be capable of receiving information from, storing information in, transmitting information to, and/or searching information stored in database 104.

Database 104 may include one or more devices configured to communicate with API standards system 102 and/or user device 106 via communication network 108. For example, database 104 may include a computing device, such as a server, a group of servers, and/or other like devices. In some non-limiting embodiments or aspects, database 104 may be associated with a transaction service provider system as discussed herein.

User device 106 may include a computing device configured to communicate with API standards system 102 and/or database 104 via communication network 108. For example, user device 106 may include a computing device, such as a desktop computer, a portable computer (e.g., a tablet computer, a laptop computer, and/or the like), a mobile device (e.g., a cellular phone, a smartphone, a PDA, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of system 100 may perform one or more functions described as being performed by another set of devices of system 100.

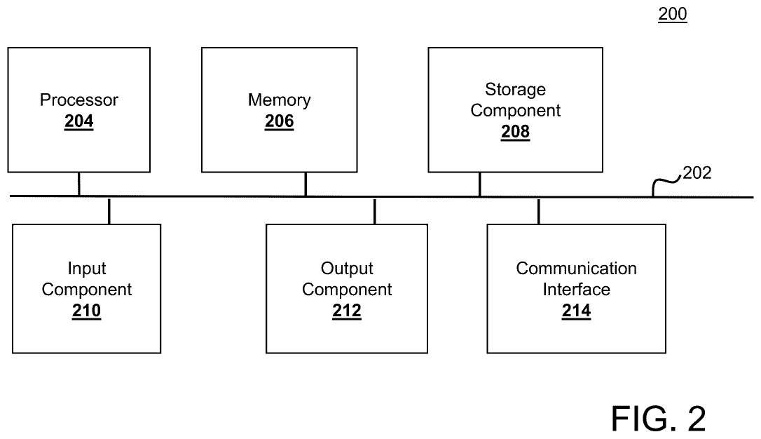

Referring now to FIG. 2, shown is a diagram of example components of a device 200. Device 200 may correspond to API standards system 102 (e.g., one or more devices of API standards system 102), database 104 (e.g., one or more devices of database 104), and/or user device 106. In some non-limiting embodiments or aspects, API standards system 102, database 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

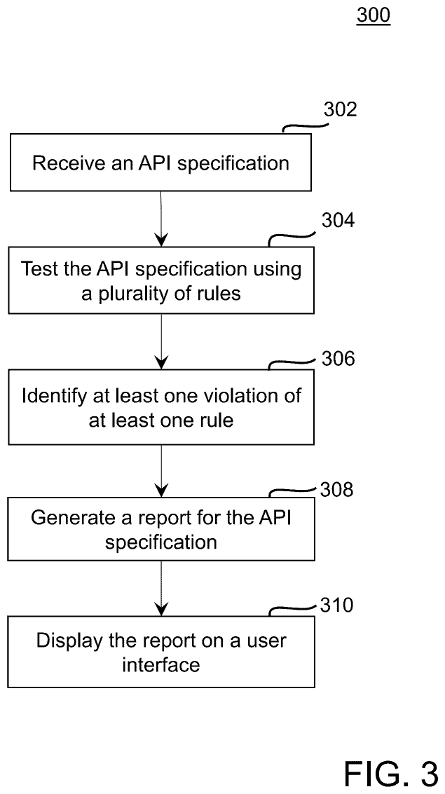

FIG. 3 is a flowchart of a process 300 for grading an API specification according to some non-limiting embodiments or aspects. In some non-limiting embodiments or aspects, one or more steps of process 300 may be performed (e.g., completely, partially, etc.) by API standards system 102 (e.g., one or more devices of API standards system 102). In some non-limiting embodiments or aspects, one or more steps of process 300 may be performed (e.g., completely, partially, etc.) by another device or group of devices separate from or including API standards system 102 (e.g., one or more devices of API standards system 102), database 104 (e.g., one or more devices of database 104), and/or user device 106.

As shown in FIG. 3, at step 302, process 300 includes receiving an API specification. For example, API standards system 102 may receive an API specification from database 104 and/or user device 106. The API specification may include a plurality of definitions. In some non-limiting embodiments or aspects, the plurality of definitions may define how one or more software applications interact with (e.g., communicate with) another one or more software applications.

As shown in FIG. 3, at step 304, process 300 includes grading (e.g., testing, evaluating, and the like) the API specification using a plurality of rules. For example, API standards system 102 may grade the API specification using the plurality of rules. The plurality of rules may be generated based on a set of existing standards (e.g., OpenAPI 3.0, Swagger 2.0, and/or the like) and/or a set of customized standards. The customized standards may provide more rigorous standards over the existing standards, standards specific to the application or environment in which the API will be used, standards reflecting preferences of the entity publishing the API, or the like.

In some non-limiting embodiments or aspects, API standards system 102 may automatically grade the API specification using the plurality of rules. For example, API standards system 102 may automatically grade the API specification using the plurality of rules by parsing the API specification into a plurality of segments and/or extracting, for each rule of the plurality of rules, at least one segment of the plurality of segments corresponding to a rule from the API specification. In some non-limiting embodiments or aspects, API standards system 102 may apply the rule to the at least one segment to determine compliance data for the at least one segment with the rule. The compliance data may indicate that the at least one segment is in compliance with the rule or that the at least one segment is not in compliance with the rule or some combination thereof (e.g., partial compliance and partial non-compliance).

As shown in FIG. 3, at step 306, process 300 includes identifying at least one violation of at least one rule. For example, API standards system 102 may identify at least one violation of at least one rule of the plurality of rules occurring in the API specification based on the compliance data. For example, API standards system 102 may identify the at least one violation based on the compliance data indicating that the at least one segment is not in compliance with the rule being applied.

As shown in FIG. 3, at step 308, process 300 includes generating a report for the API specification. For example, API standards system 102 may generate a report for the API specification based on the at least one violation of the at least one rule. In some non-limiting embodiments or aspects, the report may include data associated with the at least one violation of the at least one rule.

In some non-limiting embodiments or aspects, API standards system 102 may generate at least one score for the API specification. The at least one score may be based on a number of unique violations and/or a number of the plurality of rules, where each rule of the plurality of rules has a corresponding weight. In some non-limiting embodiments or aspects, the report may include the at least one score. For example, the report may include an API grading score for the API specification and/or an API compliance score for the API specification.

In some non-limiting embodiments or aspects, the API grading score may be a point value. For example, the API specification may have an initial point value (e.g., 100 points). In some non-limiting embodiments or aspects, the initial point value may be split between a plurality of categories corresponding to the plurality of rules. In some non-limiting embodiments or aspects, when generating the API grading score for the API specification, API standards system 102 may deduct a second point value from the initial point value of the API specification. The second point value may be based on the number of unique violations detected and/or a weight of a rule corresponding to the at least one violation of the at least one rule violation. While the API grading score has been described in terms of a numeric point value, it will be appreciated that any other API grading score format may be used, such as a letter grate, a categorization (e.g., pass/fail), and/or the like.

In some non-limiting embodiments or aspects, the API compliance score for the API specification may be a percentage value. For example, API standards system 102 may calculate the API compliance score for the API specification by reducing the initial point value by the number of unique rule violations divided by the number of the plurality of rules and multiplying the result by one hundred.

As shown in FIG. 3, at step 310, process 300 may include displaying the report on a user interface. For example, user device 106 may display the report via a user interface. In some non-limiting embodiments or aspects, the user interface may include at least one GUI. The at least one GUI may be an interactive GUI. For example, the interactive GUI may be configured to display data associated with the API specification and/or the report. The GUI may be configured to be updated based on receiving an input from a user. In some non-limiting embodiments or aspects, the interactive GUI may display data associated with one or more interactive features. For example, the interactive GUI may display data associated with an input box for receiving text input by the user, one or more selectable options for receiving a selection from the user, and/or a dropdown menu including one or more selectable options for receiving a selection from the user.

In some non-limiting embodiments or aspects, the user interface may be at least one window. The at least one window may include one or more portions. For example, the user interface may display data associated with the API specification in a first portion of a window of the user interface. Additionally or alternatively, the user interface may display data associated with the report in a second portion of the window of the user interface. In some non-limiting embodiments or aspects, the at least two portions of the window of the user interface may interact dynamically with one another. For example, the first portion of the window of the user interface including the API specification may dynamically interact with the second portion of the window of the user interface including the report. For example, in some non-limiting embodiments or aspects, selecting, by a user, of a button and/or a link within the report may automatically direct the user to a specific portion of the API specification and/or emphasize (e.g., highlight, underline, italicize, bold, isolate, and/or the like) a specific portion of the API specification. For example, an automated update to the API specification or an update to the API specification input by the user may automatically cause an updated report to be generated and displayed.

In some non-limiting embodiments or aspects, the user interface may include at least one interactive feature to facilitate remediation of the at least one violation. In some non-limiting embodiments or aspects, the at least one interactive feature may include a selectable button. The interactive feature may be embedded in the report and/or the API specification. For example, user device 106 may receive a selection of the selectable button from the user. Based on receiving the selection from the user, the API specification may be automatically modified to correct the at least one violation of the at least one rule. In some non-limiting embodiments or aspects, once the API specification is modified, API standards system 102 may automatically generate a second (updated) report for the API specification based on the modified API specification. In some non-limiting embodiments or aspects, the second report may include at least one second score (e.g., a modified API grading score and/or a modified API compliance score), which score indicates an improved compliance metric compared to the initial compliance score. In some non-limiting embodiments or aspects, upon receiving the selection from the user, the user interface may automatically update to display data associated with the modified API specification and/or the second report.

The selection of the selectable button to automatically modify the API specification to correct a violation may be used to remediate violations of a first type. Violations of the first type may be violations in which the API standards system 102 has at least a threshold confidence level that the user would accept the proposed modification to remediate the violation. Violations of the first type may not require user input or feedback in order to complete the remediation of the violations. Violations of the first type may be violations for which there is only a single modification to remediate the violation.

In some non-limiting embodiments or aspects, the at least one interactive feature may include a selectable link. The selectable link may be embedded in the report. For example, the at least one interactive feature may include a selectable link corresponding to the at least one segment of the plurality of segments. In some non-limiting embodiments or aspects, user device 106 may receive a selection of the selectable link from the user. In some non-limiting embodiments or aspects, user device 106 may display the at least one segment of the plurality of segments comprising the at least one violation of the at least one rule. For example, in response to receiving the selection of the selectable link from the user (e.g., by the user selecting the selectable link embedded in the report), the user interface may be updated to display data in the API specification associated with the at least one segment of the plurality of segments comprising the at least one violation of the at least one rule. In some non-limiting embodiments or aspects, API standards system 102 may provide at least one recommendation to modify the at least one segment to correct the at least one violation of the at least one rule. User device 106 may display the at least one recommendation provided by API standards system 102 via the user interface. The at least one recommendation may be displayed in the report and/or the API specification. Therefore, a selectable link embedded in the report may be selected by a user to automatically direct the user to the section of the API specification referred to by the section of the report in which the selectable link is embedded. This dynamic interaction between the report and the API specification enables a user to efficiently identify and/or remediate non-compliant sections of the API specification using the report.

The selection of the selectable link to direct the user to the relevant section(s) of the API specification may be used to remediate violations of a second type, although the selectable link may also be used to remediate violations of the first type. Violations of the second type may be violations in which the API standards system 102 does not satisfy at least a threshold confidence level that the user would accept the proposed modification to remediate the violation. Violations of the second type may require user input or feedback in order to complete the remediation of the violations. Violations of the second type may be violations for which there are multiple possible modifications to remediate the violation, such that user feedback to select the best possible modification is desired.

In some non-limiting embodiments or aspects, API standards system 102 may determine whether to allow or deny publication of the API specification and may automatically publish or restrict publishing based on that determination. For example, API standards system 102 may automatically determine whether to allow or deny publication of the API specification based on the at least one score and/or a threshold value. In some non-limiting embodiments or aspects, the threshold value may be a predetermined value or a value set by the user.

In some non-limiting embodiments or aspects, API standards system 102 may compare the at least one score to the threshold value. For example, API standards system 102 may compare the at least one score (e.g., the API grading score and/or the API compliance score) to the threshold value to determine whether the at least one score satisfies the threshold value. In some non-limiting embodiments or aspects, API standards system 102 may allow or deny publication of the API specification based on determining whether the at least one score satisfies the threshold value. For example, in a case where the at least one score does not satisfy the threshold value, API standards system 102 may automatically deny publication of the API specification and may prohibit publication thereof until the API specification is brought into compliance based on the API score (and updates thereto). Additionally or alternatively, in a case where the at least one score exceeds the threshold value, API standards system 102 may automatically publish the API specification.

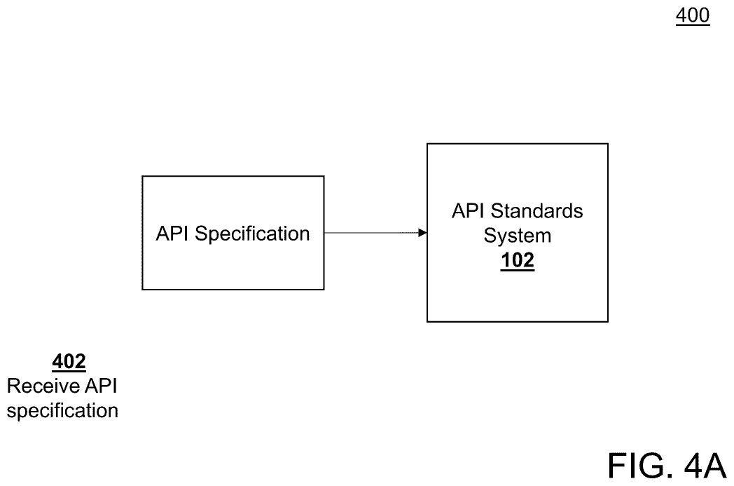

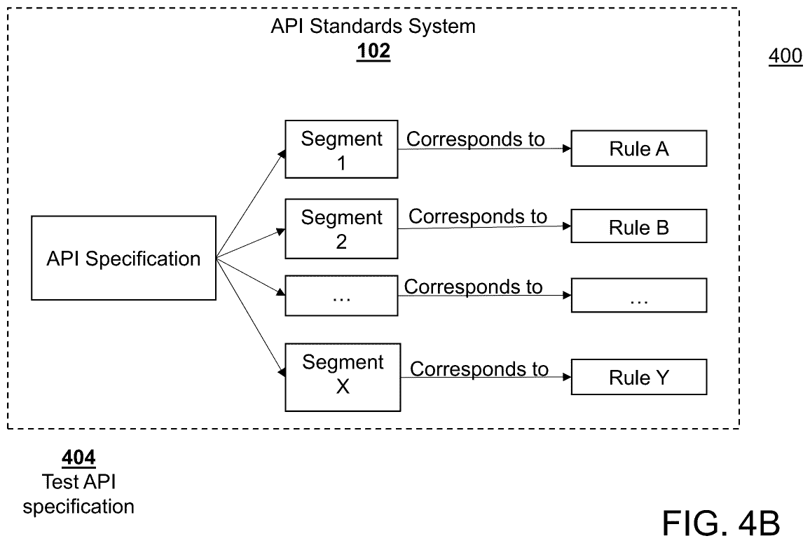

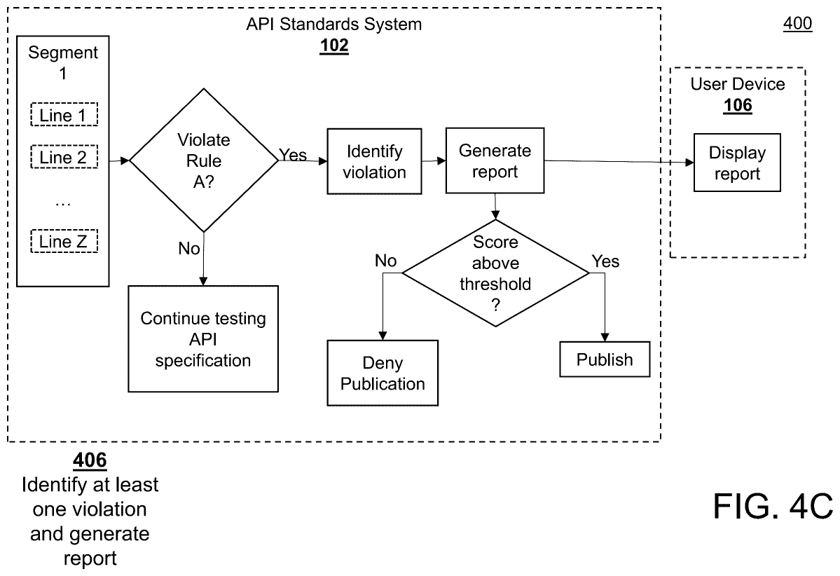

FIGS. 4A-4C are diagrams of non-limiting embodiments or aspects of an implementation 400 of the process shown in FIG. 3 (e.g., process 300) for grading an API specification. As shown in FIGS. 4A-4C, implementation 400 may include API standards system 102 (e.g., one or more device of API standards system 102) performing one or more steps of the process.

As shown in FIG. 4A, at step 402, API standards system 102 may receive an API specification. For example, API standards system 102 may receive the API specification from database 104 and/or user device 106.

As shown in FIG. 4B, at step 404, API standards system 102 may grade the API specification. For example, upon receiving the API specification, API standards system 102 may automatically grade the API specification using a plurality of rules. The plurality of rules may include an existing set of rules or standards and/or customized rules or standards as previously described. In some non-limiting embodiments or aspects, each of the plurality of rules may be categorized into one or more of a plurality of categories including, but not limited to, API complexity, Industry Standards and Compliance, Naming Conventions and Standards, Commonly accepted REST practices, Security, Error Handling, and/or Documentation. These categories may represent a type of issue raised by non-compliance of the API specification with the particular rule.

In some non-limiting embodiments or aspects, when grading the API specification, API standards system 102 may parse the API specification into a plurality of segments (e.g., Segment 1, Segment 2, and Segment X). A segment may be defined as a portion of the text of the API specification. The segment may include a line of text, a paragraph of text, or other any other relevant grouping of text.

Thus, the entire text of the API specification may be parsed into smaller segments such that the rule may be applied to each segment or only the relevant segments of the API specification. Such processes may improve the efficiency with which rules are applied to the API specification to determine compliance thereof and/or may improve identification of the non-compliant segments of the API specification to improve the efficiency with which non-compliant segments may be remediated.

As shown in FIG. 4C, at step 406, API standards system 102 may identify at least one violation of a rule and generate a report. In some non-limiting embodiments or aspects, API standards system 102 may extract, for each rule of the plurality of rules (e.g., Rule A, Rule B, Rule Y), at least one segment (e.g., Segment 1) of the plurality of segments corresponding to the rule (e.g., Rule A) from the API specification. In some non-limiting embodiments or aspects, API standards system 102 may apply the rule (e.g., Rule A) to the at least one segment (e.g., Segment 1) to determine compliance data for the at least one segment (e.g., Segment 1) with the rule (e.g., Rule A). In some non-limiting embodiments or aspects, each rule of the plurality of rules may be applied to each segment of the plurality of segments or may only be applied to relevant segments to which the rule may apply. In some non-limiting embodiments or aspects, the at least one segment may include a plurality of lines (e.g., Line 1, Line 2, Line Z). In some non-limiting embodiments or aspects, each line of the plurality of lines may be graded to determine whether the line violates the rule.

In some non-limiting embodiments or aspects, the compliance data may indicate that the at least one segment (e.g., Segment 1) does or does not violate the rule (Rule A). For example, if Segment 1 (or a portion thereof) violates Rule A, then API standards system 102 may identify at least one violation of a rule. Alternatively, if Segment 1 (or a portion thereof) does not violate Rule A, then API standards system 102 may continue grading the API specification (e.g., the next line of the current segment and/or the next segment).

In some non-limiting embodiments or aspects, API standards system 102 may generate a report for the API specification. The report may be generated based on the at least one violation of the at least one rule. In some non-limiting embodiments or aspects, the report may include data associated with the at least one violation of the at least one rule and/or at least one score. The report may identify a plurality of violations and the score generated based on those plurality of violations.

In some non-limiting embodiments or aspects, the data associated with the at least one violation may include a violations summary, a unique violations summary, and/or a reference identifier. In some non-limiting embodiments or aspects, the violations summary and/or the unique violations summary may be categorized based on a severity level. For example, violations and/or unique violations may be categorized based on severity. For example, potential categorizations of severity level may include: must, should, may, and/or hint, wherein must is the most severe violation and where hint is the least severe violation. In some non-limiting embodiments or aspects, the report may be organized based on the severity level of the at least one violation of the at least one rule.

A must violation may correspond to a violation that must be remediated before the score for the API specification may be improved to a level that may allow for publication of the API specification. For example, all must violations may be required to be remediated before the API specification may attain a score level that allows for publication thereof.

A should violation may correspond to a lower level violation compared to the must violation, but may be a violation still strongly encouraged to be addressed prior to publication of the API specification. An API specification may be published without all should violations being remediated; however, but should violations are highly encouraged to be remediated prior to publication of the API specification.

A may violation may correspond to a lower level violation compared to the should violation, and may be a violation that represents a best practice and is suggested for remediation. An API specification may be published without all may violations being remediated; however, but may violations are recommended to be remediated prior to publication of the API specification.

A hint violation may correspond to a lower level violation compared to the may violation. A hint violation may represent a minor and/or non-substantive issue suggested to be remediated before publication of the API specification. An API specification may be published without all hint violations being remediated.

The levels of severity (must, should, may, hint) may be defined by an existing standard and/or may be defined by the organization publishing the API. The levels of severity may be determined automatically based on historical data associated with published APIs and issues encountered thereby.

The level of severity of a particular violation may be represented by a weight, with the weight of higher severity violations having a higher impact on the score and the weight of lower severity violations having a lower impact on the score. The weight assigned to may violations may be higher than the weight assigned to hint violations. The weight assigned to should violations may be higher than the weight assigned to may violations. The weight assigned to must violations may be higher than the weight assigned to should violations. Violations of the same severity level may be assigned the same weight. Alternatively, violations of the same severity level may be assigned different weights based on having a different relative severity (e.g., a first should violation may be more severe than a second should violation such that the first should violation is assigned a more impactful weight than the second should violation). A non-limiting example of weighting violations is described hereinafter.

In some non-limiting embodiments or aspects, generating the report may include generating the at least one score. In some non-limiting embodiments or aspects, the at least one score may be an API grading score and/or an API compliance score. In some non-limiting embodiments or aspects, the API grading score may be a point value based on the number of rule violations and/or the severity of the rule violations and the API compliance score may be a percentage based on the API grading score.

In some non-limiting embodiments or aspects the API grading score may be generated based on the following equation, where i is a severity indicator, aCpt is the API compliance percentage, UvTy is the number of unique violations, TrTy is the total number of rules, TaRu is the total number of approved rules, aWTy is an assigned weight for the rule, const is a constant value, TvTy is the total number of violations found in the API specification for the rule, and Tv is the total number of violations found in the API specification:

$$100 - {\sum }_{i = 1}^{4} ( ( UvTy * \frac{i}{T} * rTy * \frac{i}{T} * aRu ) + ( aWTy ( i ) + ( TvTy * \frac{i}{T} * v ) ) + aCpt * const$$

In some non-limiting embodiments or aspects, when i=1 the severity is “hint”, when i=2 the severity is “may”, when i=3 the severity is “should”, and when i=4 the severity is “must”. In some non-limiting embodiments or aspects, when the severity is hint, the assigned weight aWTy, is 0.25; when the severity is may, the assigned weight, aWTy, is 0.75; when the severity is should, the assigned weight, aWTy, is 2.5; and/or when the severity is must, the assigned weight, aWTy, is 6.5. In some non-limiting embodiments or aspects, the constant value, const, may be 40.

In some non-limiting embodiments or aspects, the API compliance percentage may be calculated based on the following equation, where TUV is the total unique violations in the API specification, and where TaRu is the total approved rules:

$$100 - \frac{TUV}{TaRu} * 100$$

In some non-limiting embodiments or aspects, API standards system 102 may perform an action (e.g., publish the API specification, deny, and/or block publication of the API specification) based at least partially on the at least one score. In some non-limiting embodiments or aspects, API standards system 102 may compare the at least one score to a threshold value to determine whether the at least one score satisfies or does not satisfy the threshold value. For example, API standards system 102 may compare the API compliance score and/or the API grading score to the threshold value to determine whether the API compliance score and/or the API grading score satisfies or does not satisfy the threshold value. In some non-limiting embodiments or aspects, API standards system 102 may automatically allow or automatically publish and/or deny publication of the API specification based on determining whether the at least one score satisfies the threshold value. The threshold value may be a predetermined value and/or a value set by the user.

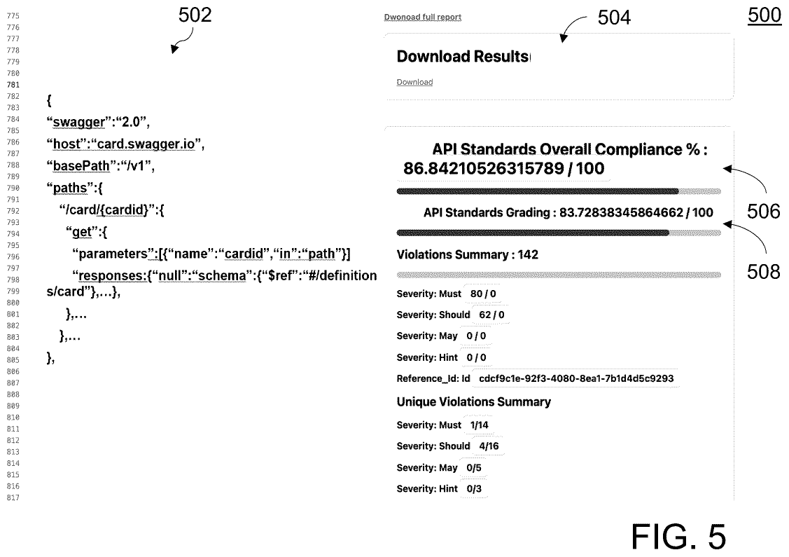

Referring now to FIG. 5, shown is an exemplary implementation of a user interface 500 generated based on grading an API specification according to some non-limiting embodiments or aspects. In some non-limiting embodiments or aspects, API standards system 102 may transmit the report to database 104 and/or user device 106. In some non-limiting embodiments or aspects, user device 106 may receive the report from API standards system 102. In some non-limiting embodiments or aspects, user device 106 may display the report via user interface 500 of the user device. User interface 500 may be an interactive GUI configured to receive input from the user and/or update based on receiving input from the user. In some non-limiting embodiments or aspects, user interface 500 may include one or more windows displayed on one or more screen of user device 106.

As seen in FIG. 5, user interface 500 may include one or more portions of a window 502, 504 of user interface 500. In some non-limiting embodiments or aspects, the user interface may display the API specification in a first portion of the window 502 of the user interface 500 and/or the report in a second portion of the window 504 of the user interface 500.

In some non-limiting embodiments or aspects, user interface 500 may include at least one interactive feature. For example, the at least one interactive feature may be a selectable feature (e.g., a selectable link, a selectable button, a selectable icon, and/or the like) configured to receive at least one selection from a user and/or an input window configured to receive at least one input from a user. In some non-limiting embodiments or aspects, the report may interact dynamically with the API specification. For example, the first portion of the window 502 of user interface 500 may update based at least on one input from the user into an interactive feature (e.g., a selectable option, an input window, a dropdown menu, and/or the like) of the second portion of the window 504 of user interface 500, and/or vice versa.

In some non-limiting embodiments or aspects, the at least one interactive feature may be configured to facilitate remediation of the at least one violation. In some non-limiting embodiments or aspects, based on receiving a selection from the user of the at least one interactive feature, API standards system 102 may modify (e.g., automatically) the API specification, generate a modified API specification, and/or generate a second report based on the modified API specification which may include at least one second score. The at least one second score may be a second API grading score and/or a second API compliance score generated based on the modified API specification. In some non-limiting embodiments or aspects, user interface 500 may display data associated with an API compliance score 506 and/or data associated with an API grading score 508. The interface 500 may display a summary of the total number of violations occurring in the API specification. The interface 500 may display a breakdown of the number of violations based on severity (e.g., how many must violations, should violations, may violations, hint violations, and/or the like).

In some non-limiting embodiments or aspects, the interactive feature may include a selectable button, that when selected by the user, automatically causes API standards system 102 to modify the API specification to correct the at least one violation of the at least one rule. The selectable button may be linked to data associated with a suggestion and/or a recommendation provided by API standards system 102 for modifying the API specification based on the at least one violation of the at least one rule. The suggestion and/or recommendation may include instructions to manually modify the API specification and/or a suggestion for automatically modifying the API specification to be in compliance with the at least one rule. In response to automatically modifying the API specification, API standards system 102 may automatically generate a second report for the API specification based on the modified API specification.

In some non-limiting embodiments or aspects, the at least one interactive feature may include a selectable link corresponding to at least one segment of the plurality of segments. Upon receiving a selection of the selectable link from a user, user interface 500 may update to display the at least one segment of the plurality of segments comprising the at least one violation of the at least one rule. In some non-limiting embodiments or aspects, upon receiving a selection of the selectable link, user interface 500 may update such that the first portion of the window 502 of user interface 500 displays the at least one segment of the plurality of segments comprising the at least one violation of the at least one rule. Additionally or alternatively, upon receiving a selection of the selectable link, user interface 500 may update such that the second portion of the window 504 of user interface 500 displays at least one recommendation, provided by API standards system 102, to modify the at least one segment to correct the at least one violation of the at least one rule.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for grading an application programming interface (API) specification comprising:
receiving, with at least one processor, an API specification;
automatically grading, with at least one processor, the API specification using a plurality of rules by:
parsing, with at least one processor, the API specification into a plurality of segments; and
for each rule of the plurality of rules, extracting, with at least one processor, at least one segment of the plurality of segments corresponding to the rule from the API specification and applying, with at least one processor, the rule to the at least one segment to determine compliance data for the at least one segment with the rule;
based on the compliance data, automatically identifying, with at least one processor, at least one violation of at least one rule of the plurality of rules occurring in the API specification;
generating, with at least one processor, a report for the API specification based on the at least one violation of the at least one rule, wherein the report comprises data associated with the at least one violation of the at least one rule and at least one score; and
displaying, with at least one processor, the report on a user interface comprising at least one interactive feature configured to facilitate remediation of the at least one violation.

2. The computer-implemented method of claim 1, wherein the at least one interactive feature is a selectable button, the method further comprising:
receiving a selection of the selectable button from a user;
automatically modifying the API specification to correct the at least one violation of the at least one rule; and
generating a second report for the API specification based on the modified API specification, wherein the second report comprises at least one second score.

3. The computer-implemented method of claim 1, wherein the at least one interactive feature is a selectable link corresponding to the at least one segment of the plurality of segments, the method further comprising:
receiving a selection of the selectable link from a user;
displaying the at least one segment of the plurality of segments comprising the at least one violation of the at least one rule; and
providing at least one recommendation to modify the at least one segment to correct the at least one violation of the at least one rule.

4. The computer-implemented method of claim 1, further comprising generating the at least one score based on a number of unique violations and a number of the plurality of rules, wherein each rule of the plurality of rules has a corresponding weight.

5. The computer-implemented method of claim 1, further comprising determining whether to allow or deny publication of the API specification based on the at least one score and a threshold value.

6. The computer-implemented method of claim 5, further comprising:
comparing the at least one score to the threshold value;
determining that the at least one score does not satisfy the threshold value; and
denying publication of the API specification based on determining that the at least one score does not satisfy the threshold value.

7. The computer-implemented method of claim 5, further comprising:
comparing the at least one score to the threshold value;
determining the at least one score satisfies the threshold value; and
automatically publishing the API specification based on determining the at least one score satisfies the threshold value.

8. The computer-implemented method of claim 1, wherein the user interface displays the API specification in a first portion of a window of the user interface and the report in a second portion of the window of the user interface, and wherein the report interacts dynamically with the API specification.

9. A system for grading an application programming interface (API) specification comprising at least one processor, wherein the at least one processor is programmed or configured to:
receive an API specification;
automatically grade the API specification using a plurality of rules, wherein when grading the API specification, the at least one processor is programmed or configured to:
parse the API specification into a plurality of segments; and
for each rule of the plurality of rules, extract at least one segment of the plurality of segments corresponding to the rule from the API specification and apply the rule to the at least one segment to determine compliance data for the at least one segment with the rule;
based on the compliance data, automatically identify at least one violation of at least one rule of the plurality of rules occurring in the API specification;
generate a report for the API specification based on the at least one violation of the at least one rule, wherein the report comprises data associated with the at least one violation of the at least one rule and at least one score; and
display the report on a user interface comprising at least one interactive feature configured to facilitate remediation of the at least one violation.

10. The system of claim 9, wherein the at least one interactive feature is a selectable button, and wherein the at least one processor is programmed or configured to:
receive a selection of the selectable button from a user;
automatically modify the API specification to correct the at least one violation of the at least one rule; and
generate a second report for the API specification based on the modified API specification, wherein the second report comprises at least one second score.

11. The system of claim 9, wherein the at least one interactive feature is a selectable link corresponding to the at least one segment of the plurality of segments, and wherein the at least one processor is programmed or configured to:
receive a selection of the selectable link from a user;
display the at least one segment of the plurality of segments comprising the at least one violation of the at least one rule; and
provide at least one recommendation to modify the at least one segment to correct the at least one violation of the at least one rule.

12. The system of claim 9, wherein the at least one processor is further programmed or configured to generate the at least one score based on a number of unique violations and a number of the plurality of rules, wherein each rule of the plurality of rules has a corresponding weight.

13. The system of claim 9, wherein the at least one processor is further programmed or configured to determine whether to allow or deny publication of the API specification based on the at least one score and a threshold value.

14. The system of claim 13, wherein the at least one processor is further programmed or configured to:
compare the at least one score to the threshold value;
determine whether the at least one score satisfies the threshold value; and
deny publication of the API specification based on determining that the at least one score does not satisfy the threshold value; or
automatically publish the API specification based on determining that the at least one score satisfies the threshold value.

15. The system of claim 9, wherein the user interface displays the API specification in a first portion of a window of the user interface and the report in a second portion of the window of the user interface, and wherein the report interacts dynamically with the API specification.

16. A computer program product for grading an application programming interface (API) specification, the computer program product comprising at least one non-transitory computer-readable medium including one or more instructions that, when executed by at least one processor, cause the at least one processor to:
receive an API specification;
automatically grade the API specification using a plurality of rules, wherein when grading the API specification, the one or more instructions cause the at least one processor to:
parse the API specification into a plurality of segments; and
for each rule of the plurality of rules, extract at least one segment of the plurality of segments corresponding to the rule from the API specification and apply the rule to the at least one segment to determine compliance data for the at least one segment with the rule;
based on the compliance data, automatically identify at least one violation of at least one rule of the plurality of rules occurring in the API specification;
generate a report for the API specification based on the at least one violation of the at least one rule, wherein the report comprises data associated with the at least one violation of the at least one rule and at least one score; and
display the report on a user interface comprising at least one interactive feature configured to facilitate remediation of the at least one violation.

17. The computer program product of claim 16, wherein the at least one interactive feature is a selectable button, and wherein the one or more instructions cause the at least one processor to:
receive a selection of the selectable button from a user;
automatically modify the API specification to correct the at least one violation of the at least one rule; and
generate a second report for the API specification based on the modified API specification, wherein the second report comprises at least one second score.

18. The computer program product of claim 16, wherein the at least one interactive feature is a selectable link corresponding to the at least one segment of the plurality of segments, and wherein the one or more instructions cause the at least one processor to:
receive a selection of the selectable link from a user;
display the at least one segment of the plurality of segments comprising the at least one violation of the at least one rule; and
provide at least one recommendation to modify the at least one segment to correct the at least one violation of the at least one rule.

19. The computer program product of claim 16, wherein the one or more instructions further cause the at least one processor to generate the at least one score based on a number of unique violations and a number of the plurality of rules, wherein each rule of the plurality of rules has a corresponding weight.

20. The computer program product of claim 16, wherein the one or more instructions further cause the at least one processor to:
determine whether to allow or deny publication of the API specification based on the at least one score and a threshold value,
wherein when determining whether to allow or deny publication of the API specification, the one or more instructions cause the at least one processor to:
compare the at least one score to the threshold value;
determine whether the at least one score satisfies the threshold value; and
deny publication of the API specification based on determining that the at least one score does not satisfy the threshold value; or
automatically publish the API specification based on determining that the at least one score satisfies the threshold value.
